(19) United States
(12) Patent Application Publication
(10) Pub. No.: US 2021/0307369 A1
(43) Pub. Date: Oct. 7, 2021

(54) REDUCING FAT ABSORPTION IN PREPARED FOODS

(71) Applicant: Pacific Foods Solutions, LLC, Noblesville, IN (US)

(72) Inventors: Chris J. Lyden, Auburn, WA (US); Peter G. Williamson, Gloucester, MA (US)

(73) Assignee: Pacific Foods Solutions, LLC, Noblesville, IN (US)

(21) Appl. No.: 17/219,771

(22) Filed: Mar. 31, 2021

Related U.S. Application Data
(60) Provisional application No. 63/005,016, filed on Apr. 3, 2020.

(51) Int. Cl. A23L 5/10; A21D 10/04; A23L 33/185

(52) U.S. Cl. CPC A23L 5/11; A23L 33/185; A21D 10/04

(57) ABSTRACT

Described herein are compositions and processes for reducing the amount of fat in and increasing the moisture content of foods cooked in cooking oils.

### CROSS-REFERENCE TO RELATED APPLICATIONS

This application claims the benefit under 35 U.S.C § 119(e) of U.S. Provisional Application No. 63/005,016 filed on Apr. 3, 2020, the entirety of the disclosure of which is incorporated herein by reference.

### BACKGROUND OF THE INVENTION

This invention relates to processes for reducing oil and fat content in breaded or battered, cooked or partially cooked food. More particularly, this invention relates to such a process which utilizes a modified protein from a vegetable or animal source to control oil and fat content in food.

When foods such as meat, vegetables, fish, pastry, fritters, doughnuts, snack foods or the like are cooked at an elevated temperature in oil and/or fat those cooked foods typically contain absorbed oil and/or fat in addition to the fat that normally occurs in those foods. Health conscious consumers often prefer foods with lower fat content over similar food items that contain more fat. Consequently, there is a need for a means to reduce the amount of fat or oil that is absorbed into those foods during the cooking process.

In addition to absorbing fat during cooking in oil or fat, items cooked at elevated temperatures may lose enough moisture to adversely affect the texture or flavor profile of the cooked item. This can make the cooked items less attractive to the consumer. For that reason, limiting moisture loss during cooking is also a goal of the invention described herein.

Accordingly, it is desirable to provide a form of food including fish, meat, vegetables, pastry, snack foods or the like which can be cooked while minimizing or preventing absorption of oil or fat by the food during cooking and minimizing moisture loss. In addition, it would be desirable to provide such a form of food which is not less nutritional than the original food or which is even more nutritional than the original food to be cooked.

### SUMMARY

In accordance with this invention, uncooked food to be cooked with liquid oil and/or fat, including butter is coated with an aqueous protein solution prepared as described herein. The protein of the aqueous protein solution can be a protein from a meat, fish, seafood, or vegetable source.

In one embodiment of the invention, the aqueous protein solution is applied to the surface of the breaded or battered food to be cooked. The breaded or battered food coated with the aqueous protein solution, then can be cooked in liquid oil and/or fat at elevated temperature while minimizing absorption of oil and/or fat by the food. The difference in weight of fat and/or oil between food treated in accordance with this invention after being cooked in oil and/or fat compared with food without the aqueous protein solution coating after being cooked in oil and/or fat may be between about 30 and about 50%, more preferably, between about 40 and about 50% less oils and/or fat. In addition, since the amount of absorbed fat or oil utilized during cooking may be substantially reduced, the amount of oil or fat needed to cook a given weight of food may be correspondingly substantially reduced.

### DETAILED DESCRIPTION

In one embodiment of the invention described herein, breaded or battered food to be cooked in oil and/or fat is coated with an aqueous protein solution made from meat, fish, or vegetable protein, including pea protein.

It is appreciated that the quality of the protein compositions, sought after for their applications in human and animal foods, is based on several functional properties of the proteins constituting the compositions taken individually. For use in minimizing fat or oil absorption during cooking, it is believed that several functional properties like the proteins' ability to bind water, their foaming, dispersing, gelling and emulsifying capacity, their solubility and their thermostability, and the like, may affect minimization of fat or oil absorption. These same factors may influence moisture retention in the cooked food. It has been found that these properties may be influenced by the pH of the protein mixture composition. In many applications it is preferred that the protein mixture exhibits nearly complete water solubility.

Factors that influence the solubility of the protein mixtures used for pre-treatment of cooked foods, are the concentration of the proteins, the source of the protein, prior treatment of the protein (may vary by commercial source) and the pH of the protein solution. For example, pea protein conventionally exhibit excellent solubility at alkaline pH and at acidic pH. The lowest solubility is obtained in pH regions close to the isoelectric pH of the proteins constituting the isolates, i.e., pH regions ranging from 4 to 6.

Known conventional processes can be utilized to obtain protein compositions useful for this invention.

Know conventional process for applying the aqueous protein solution coating to the food to be cooked can be utilized in this invention.

Suitable sources of protein for the protein compositions include meat, poultry and fish, including shell fish, and vegetable. Non-limiting examples of fish include deboned flounder, sole, haddock, cod, sea bass, salmon, tuna, trout, or the like. Non-limiting examples of shell fish include shelled/unshelled shrimp, crabmeat, crayfish, lobster, scallops, oysters, or the like. Non-limiting examples of meat include, beef, lamb, pork, venison, veal, elk, buffalo, or the like. Non-limiting example of poultry include chicken, turkey, duck, game bird, goose, or the like. Non-limiting examples of vegetable protein include soybean, pea, or the like.

The aqueous protein solution also can contain flavorings such as salt, spices, butter flavor or garlic flavor or the like.

Suitable oils and/or fats, including hydrogenated or non-hydrogenated oils which can be utilized to effect cooking of uncooked food are those conventionally used in cooking including lard, peanut oil, corn oil, vegetable oil, canola oil, olive oil, palm oil, coconut oil, sesame oil, sunflower oil, butter, mixtures thereof, or the like.

The uncooked food which is modified as described herein include meat, poultry and fish, including shell fish, vegetables, including potato or onion, tempura; nuts, seeds, legumes, mushrooms, flour based foods such as batter compositions, pastry compositions, or the like.

Non-limiting examples of fish include deboned flounder, sole, haddock, cod, sea bass, salmon, tuna, trout, pollock, or the like. Non-limiting examples of shell fish include shelled/unshelled shrimp, crabmeat, crayfish, lobster, scallops, oysters, or shrimp in the shell, or the like.

Non-limiting examples of meats include ham, beef, lamb, pork, venison, veal, elk, buffalo or the like; poultry such as chicken, mechanically deboned poultry meat, turkey, duck, game bird or goose, or the like either in fillet form or in ground form.

Non-limiting examples of vegetables suitable for use include potato, sweet potato, carrot, parsnip, cauliflower, okra, onion, green beans, eggplant, corn, zucchini, or the like.

Other non-limiting foods include mushroom, nuts, batter compositions such as those comprising flour, egg and milk which can include additional food such as cornmeal, cracker meal or dusting meals.

The food coated with the aqueous protein solution then can be cooked with oil and/or fat in a conventional manner such as by deep fat frying, pan frying, or the like. It has been found that the cooked food provided in accordance with this invention contains between about 30% and about 55%, preferably between about 40% and about 55% less oil and/or fat by weight as compared to the same cooked food not modified by the protein of this invention. The amount of fat or oil needed to cook a given weight of a given type of food also may be correspondingly reduced.

The cooked food coated with the aqueous protein solution can then be frozen following best manufacturing practices. It has been found that the frozen cooked food provided in accordance with this invention exhibits up to a 5% increase by weight as compared to the same frozen cooked food not modified by the protein of this invention. The increased moisture provides a yield advantage over untreated cooked/frozen product. Additionally, the increased moisture leads to less degradation of the product due to freezer dehydration and storage over time.

Below are non-limiting embodiments of the invention

In one embodiment a process for reducing the level of absorbed fat in a prepared food comprises the steps of:

a) preparing a protein solution of a protein at a pH of from about 9.5 to about 9.8, wherein the protein solution contains about 1 part of protein to from about 6 parts of water to about 20 parts of water by weight.

b) adding the protein solution of step a) to a batter or applying the protein solution of step a) onto the surface of a breaded or battered prepared food.

In another embodiment a process for increasing the level of retained moisture in a prepared food comprises the steps of:

a) preparing a protein solution of a protein at a pH of from about 9.5 to about 9.8, wherein the protein solution contains about 1 part of protein to from about 6 parts of water to about 20 parts of water by weight.

b) adding the protein solution of step a) to a batter or applying the protein solution of step a) onto the surface of a breaded or battered prepared food.

In another embodiment, any of the embodiments listed above wherein the protein solution is sprayed onto the surface of a breaded or battered prepared food or the breaded or battered prepared food is dipped in the protein solution.

In another embodiment, the process of any of the embodiments listed above, wherein the protein solution is made with a vegetable protein, a meat protein, or a fish protein.

In another embodiment, the process of any of the embodiments listed above, wherein the protein solution contains from about I part of protein to from about 6 parts of water to about 15 parts of water.

In another embodiment, the process of any of the embodiments listed above, wherein the protein solution contains from about 1 part of protein to from about 6 parts of water to about 10 parts of water.

In another embodiment, the process of any of the embodiments listed above wherein the protein is selected from meat, poultry and fish, including shell fish, and vegetable.

In another embodiment, the process of any of the embodiments listed above wherein the protein is selected from deboned flounder, sole, haddock, cod, sea bass, salmon, tuna, pollock, trout, shelled/unshelled shrimp, crabmeat, crayfish, lobster, scallops, oysters, beef, lamb, pork, venison, veal, elk, buffalo, chicken, turkey, duck, game bird, goose, soybean, pea.

In another embodiment, the process of any of the embodiments listed above, wherein the prepared food is selected from the group consisting of meat, poultry and fish, including shell fish, and vegetable.

In another embodiment, the process of any of the embodiments listed above, wherein the prepared food is meat.

In another embodiment, the process of any of the embodiments listed above, wherein the prepared food is poultry.

In another embodiment, the process of any of the embodiments listed above, wherein the prepared food is fish.

In another embodiment, the process of any of the embodiments listed above, wherein the prepared food is shell fish.

In another embodiment, the process of any of the embodiments listed above, wherein the prepared food is vegetable.

In another embodiment, the process of any of the embodiments listed above, wherein the meat is selected from the group consisting of beef, lamb, pork, venison, veal, elk, and buffalo

In another embodiment, the process of any of the embodiments listed above, wherein the poultry is selected from the group consisting of chicken, turkey, duck, game bird, and goose.

In another embodiment, the process of any of the embodiments listed above, wherein the fish is selected from the group consisting of deboned flounder, sole, haddock, cod, sea bass, salmon, tuna, pollock and trout.

In another embodiment, the process of any of the embodiments listed above, wherein the shell fish is selected from the group consisting of shelled/unshelled shrimp, crabmeat, crayfish, lobster, scallops, and oysters.

In another embodiment, the process of any of the embodiments listed above, wherein the vegetable is selected from the group consisting of potato, sweet potato, carrot, parsnip, cauliflower, okra, onion, green beans, eggplant, corn, or zucchini.

In another embodiment, the process of any of the embodiments listed above wherein the protein is the same protein comprising the breaded or battered prepared food.

### NON-LIMITING EXAMPLES OF FAT BLOCKING PROTEIN RECIPES

Treatment 1: A basic tilapia solution was prepared by grinding tilapia fillet muscle with water to produce a suspension or solution. The solution/suspension consisted of 1 part tilapia muscle to 6 parts water. Depending on the application, up to 20 parts water may be used. Sodium hydroxide (4N) was then added to this solution to produce a basic tilapia solution having a pH of 9.5-9.8.

Treatment 2: A basic pea protein solution was prepared by mixing a commercially available pea protein powder with water to produce a suspension or solution. The solution/suspension consisted of 1 part protein to 6 parts water. Depending on the application, up to 20 parts water may used. Sodium hydroxide (4N) was then added to this solution to produce a basic pea protein solution having a pH of 9.5-9.8.

Treatment 3: A basic soy protein solution was prepared by mixing a commercially available soy protein powder with water to produce a suspension or solution. The solution/suspension consisted of 1 part protein to 6 parts water. Depending on the application, up to 20 parts water may be used. Sodium hydroxide (4N) was then added to this solution to produce a basic soy solution having a pH of 9.5-9.8.

Treatment 4: A basic chicken protein solution was prepared by grinding chicken meat with water to produce a suspension or solution. The solution/suspension consisted of 1 part chicken meat to 6 parts water. Depending on the application, up to 20 parts water may be used. Sodium hydroxide (4N) was then added to this solution to produce a basic chicken solution having a pH of 9.5-9.8.

Treatment 5: Pollock cuttings were ground to a powder. This powder can be frozen (treatment 5b) and used later or used immediately (treatment 5a) to form a solution or suspension of protein consisting of 1 part pollock to 6 parts water. Depending on the application, up to 20 parts water may be used. Sodium hydroxide (4N) was then added to this solution to produce a basic pollock solution having a pH of 9.5-9.8.

The treatments were then incorporated into a batter mixture or coated on the outside of a breaded product prior to par frying. In the following examples all foods were par fried at an oil temperature of 350° F. for 30 seconds.

The following results are an average of multiple trials:

Battered Product

| | | PFS | | | Fat | | Moisture | | Calories |
|---|---|---|---|---|---|---|---|---|---|
| Test | Raw | Functional | | | vs | | vs | | vs |
| ID | Material | Protein | Treatment | Fat | Control | Moisture | Control | Calories | Control |
| C1 | Tilapia | Control | Batter | 6.00% | | 67.50% | | 155 | |
| T1 | Tilapia | Treatment 1 | Batter | 3.65% | −42.97% | 68.60% | 1.63% | 136 | −12.54% |
| P1 | Tilapia | Treatment 2 | Batter | 3.45% | −46.09% | 64.15% | −4.96% | 133 | −14.47% |
| S1 | Tilapia | Treatment 3 | Batter | 3.30% | −48.44% | 69.70% | 3.26% | 130 | −16.40% |
| CSB | Shrimp | Control | Batter | 5.90% | | 65.80% | | 156 | |
| TSB | Shrimp | Treatment 1 | Batter | 4.40% | −25.42% | 66.60% | 1.22% | 145 | −7.05% |
| PSB | Shrimp | Treatment 2 | Batter | 4.40% | −25.42% | 67.20% | 2.13% | 143 | −8.33% |
| SSB | Shrimp | Treatment 3 | Batter | 3.70% | −37.29% | 67.40% | 2.43% | 149 | −4.49% |
| PC1 | Pollock | Control | Batter | 7.7% | | 65.1% | | 172 | |
| F1 | Pollock | Treatment 5a | Batter | 5.0% | −35.06 | 66.1% | 1.54% | 155 | −9.88% |
| F2 | Pollock | Treatment5b | Batter | 5.8% | −24.68 | 68.0% | 4.45% | 151 | −12.21% |

Batter & Breaded Product

| | | PFS | | | Fat | | Moisture | | Calories |
|---|---|---|---|---|---|---|---|---|---|
| Test | Raw | Functional | | | vs | | vs | | vs |
| ID | Material | Protein | Treatment | Fat | Control | Moisture | Control | Calories | Control |
| C3 | Tilapia | Control | Bat & Bread | 8.05% | | 58.60% | | 200 | |
| C4 | Tilapia | Treatment 1 | Bat & Bread | 5.80% | −27.95% | 61.60% | 5.12% | 177 | −11.75% |
| T3 | Tilapia | Treatment 2 | Bat & Bread | 5.60% | −30.43% | 60.60% | 3.41% | 180 | −10.25% |
| T4 | Tilapia | Treatment 3 | Bat & Bread | 5.95% | −26.09% | 60.55% | 3.33% | 182 | −9.25% |
| P3 | Shrimp | Control | Bat & Bread | 7.50% | | 53.00% | | 218 | |
| P4 | Shrimp | Treatment 1 | Bat & Bread | 6.40% | −14.67% | 56.10% | 5.85% | 200 | −8.26% |
| S3 | Shrimp | Treatment 2 | Bat & Bread | 6.80% | −9.33% | 57.10% | 7.74% | 199 | −8.72% |
| S4 | Shrimp | Treatment 3 | Bat & Bread | 6.00% | −20.00% | 54.60% | 3.02% | 204 | −6.42% |

Cook Yields on Batter & Breaded Products

| | | PFS | | | | | | Yield |
|---|---|---|---|---|---|---|---|---|
| Test | Raw | Functional | | Pre Cook | Post Cook | Cook | Cook | Increase |
| ID | Material | Protein | Treatment | Weight(g) | Weight(g) | Gain(g) | Gain (%) | vs Control |
| C3 | Tilapia | Control | Bat & Bread | 138.00 | 142.25 | 4.25 | 3.09% | |
| C4 | Tilapia | Treatment 1 | Bat & Bread | 146.75 | 157.00 | 10.25 | 7.00% | 126.50% |
| T3 | Tilapia | Treatment 2 | Bat & Bread | 138.00 | 145.75 | 7.75 | 5.73% | 85.55% |
| T4 | Tilapia | Treatment 3 | Bat & Bread | 132.75 | 145.50 | 12.75 | 9.57% | 209.69% |
| P3 | Shrimp | Control | Bat & Bread | 94.00 | 96.00 | 2.00 | 2.13% | |
| P4 | Shrimp | Treatment 1 | Bat & Bread | 82.50 | 89.50 | 7.00 | 8.48% | 298.79% |
| S3 | Shrimp | Treatment 2 | Bat & Bread | 82.00 | 97.50 | 15.50 | 18.90% | 788.41% |
| S4 | Shrimp | Treatment 3 | Bat & Bread | 86.50 | 95.50 | 9.00 | 10.40% | 389.02% |

| | | | PFS | | | | Moisture |
|---|---|---|---|---|---|---|---|
| | | | Functional | | Fat vs | | vs |
| Test ID | Base Materials | Treatment | Protein | Fat | Control | Moisture | Control |
| APPETIZ- | Batter & Breaded | | | | | | |
| ERS | Product | | | | | | |
| 1 | Mozzarella Stick | Control Fried | — | 16.10 | | 42.01 | |
| 2 | Mozzarella Stick | Protein Fried | Chicken | 12.92 | −19.75% | 46.34 | 9.34% |
| 3 | Mushroom | Control Fried | — | 11.05 | | 61.88 | |
| 4 | Mushroom | Protein Fried | Chicken | 6.45 | −41.63% | 67.42 | 8.22% |
| 5 | Onion Rings | Control Fried | — | 17.92 | | 41.08 | |
| 6 | Onion Rings | Protein Fried | Chicken | 9.74 | −45.65% | 51.87 | 20.80% |
| 7 | Stuffed Jalapeno | Control Fried | — | 15.88 | | 59.60 | |
| 8 | Stuffed Jalapeno | Protein Fried | Chicken | 7.81 | −50.82% | 49.49 | −20.43% |
| 1 | Zucchini Sticks | Control Fried | — | 10.26 | | 61.06 | |
| 2 | Zucchini Sticks | Protein Fried | Chicken | 8.95 | −12.77% | 60.64 | −0.69% |
| 3 | Zucchini Sticks | Control Fried | — | 14.33 | | 50.72 | |
| 4 | Zucchini Sticks | Protein Fried | Chicken | 11.89 | −17.03% | 52 | 2.46% |
| 5 | Cauliflower | Control Fried | — | 12.14 | | 58.29 | |
| 6 | Cauliflower | Protein Fried | Chicken | 10.51 | −13.43% | 59.12 | 1.40% |
| FRENCH | | | | | | | |
| FRIES | | | | | | | |
| 3F | Potato (FF) | Control Fried | — | 8.55% | | 53.30% | |
| 1M | Potato (FF) | Protein Fried | Chicken | 6.94% | −18.83% | 60.08% | 11.28% |
| Control | Potato (FE) | Control Fried | — | 8.80% | | 55.05% | |
| PDFF | Potato (FF) | Protein Fried | Chicken | 6.75% | −23.30% | 56.76% | 3.01% |
| PDFF | Potato (FF) | Protein Fried | Chicken | 8.06% | −8.41% | 57.29% | 4.07% |
| PDFF | Potato (FF) | Protein Fried | Chicken | 6.75% | −23.30% | 58.30% | 5.90% |
| 1 | Potato (FF) | Control Fried | — | 9.09% | | 50.94% | |
| 2 | Potato (FF) | Protein Fried | Chicken | 5.11% | −43.78% | 59.04% | 13.72% |
| 3 | Potato (FF) | Protein Fried | Chicken | 5.38% | −40.81% | 58.78% | 15.39% |
| 4 | Potato (FF) | Protein Fried | Chicken | 6.57% | −27.72% | 56.24% | 10.40% |
| 1 | Potato (FF) | Control Fried | — | 3.94% | | 71.87% | |
| 3 | Potato (FF) | Protein Fried | Pollock | 3.18% | −19.29% | 72.85% | 1.35% |
| 4 | Potato (FF) | Protein Fried | Pollock | 2.64% | −32.99% | 73.31% | 2.00% |
| 2 | Potato (FF) | Control Fried | — | 9.04% | | | |
| 3 | Potato (FF) | Protein Fried | Chicken | 7.20% | −20.35% | | |
| 4 | Potato (FF) | Protein Fried | Chicken | 6.01% | −33.52% | | |
| 5 | Potato (FF) | Protein Fried | Chicken | 5.01% | −44.58% | | |
| 6 | Potato (FF) | Protein Fried | Chicken | 5.89% | −34.85% | | |
| 2 | Potato (FF) | Control Fried | — | 9.12% | | | |
| 3 | Potato (FF) | Protein Fried | Chicken | 6.02% | −33.99% | | |
| 5 | Potato (FF) | Protein Fried | Chicken | 5.68% | −37.72% | | |
| 6 | Potato (FF) | Protein Fried | Chicken | 4.99% | −45.29% | | |
| DONUTS | | | | | | | |
| 1 | Fully Cooked | Control Fried | — | 11.82 | | 29.83 | |
| | Donut | | | | | | |
| 2 | Fully Cooked | Protein Fried | Chicken | 8.11 | −31.39% | 34.37 | 13.21% |
| | Donut | | | | | | |
| Tortilla | | | | | | | |
| Chips | | | | | | | |
| 1 | Fully Cooked | Control Fried | — | 33.15% | | 3.09 | |
| | Tortilla Chips | | | | | | |
| 2 | Fully Cooked | Protein Fried | Chicken | 28.57% | −13 82% | 7.39 | 58.19% |
| | Tortilla Chips | | | | | | |
| | Batter & Breaded | | | | | | |
| | Product | | | | | | |
| 1 | Mozzarella Stick | Control Fried | — | 17.60% | | 42.10% | |
| 2 | Mozzarella Stick | Protein Fried | Pea | 11.90% | −32.39% | 47.20% | 10.81% |
| 1 | Zucchini | Control Fried | — | 8.30% | | 68.50% | |
| | Medallions | | | | | | |
| 2 | Zucchini | Protein Fried | — | 4.20% | −49.40% | 71.80% | 4.60% |
| | Medallions | | | | | | |
| 1 | Chicken Cutlets | Control Fried | — | 8.80% | | 63.80% | |
| 2 | Chicken Cutlets | Protein Fried | Chicken | 3.98% | −54.77% | 70.10% | 8.99% |
| 1 | Pork Cutlets | Control Fried | — | 10.40% | | 57.60% | |
| 2 | Pork Cutlets | Protein Fried | Pork | 4.00% | −61.54% | 65.20% | 11.66% |
| 1 | Steak Cutlets | Control Fried | — | 15.00% | | 42.40% | |
| 2 | Steak Cutlets | Protein Fried | Beef | 5.20% | −65.33% | 58.90% | 28.01% |

The following are results of Acid vs Alkaline Treatments using a chicken protein solution (see treatment 4 above)

Acid vs Alkaline Fat Block Testing
Marinated-Breaded-Dipped (if applicable)-Par Fried

| | | | % | | % | | % | | % | | % | | % |
|---|---|---|---|---|---|---|---|---|---|---|---|---|---|
| | | | Change | | Change | | Change | | Change | | Change | | Change |
| | | | vs. | | vs. | | vs. | | vs. | | vs. | | vs. |
| Sample | Control | 2.8 pH | Control | 5.5 pH | Control | 7.3 pH | Control | 8.5 pH | Control | 9.5 pH | Control | 11 pH | Control |
| Fat | 9.83 | 7.27 | −26.0% | 7.04 | −28.4% | 6.95 | −29.3% | 6.64 | −32.5% | 6.2 | −36.9% | 6.83 | −30.5% |
| Moisture | 56.47 | 60.13 | 6.5% | 60.01 | 6.3% | 59.46 | 5.3% | 59.1 | 4.7% | 61.28 | 8.5% | 61.17 | 8.3% |

What is claimed is:

1. A process for reducing the level of absorbed fat in a prepared food comprising the steps of:
a) preparing a protein solution of a protein at a pH of from about 9.5 to about 9.8, wherein the protein solution contains about 1 part of protein to from about 6 parts of water to about 20 parts of water by weight.
b) adding the protein solution of step a) to a batter or applying the protein solution of step a) onto the surface of a breaded, battered, or unbattered prepared food.

2. A process for increasing the level of retained moisture in a prepared food comprising the steps of:
a) preparing a protein solution of a protein at a pH of from about 9.5 to about 9.8, wherein the protein solution contains about 1 part of protein to from about 6 parts of water to about 20 parts of water by weight.
b) adding the protein solution of step a) to a batter or applying the protein solution of step a) onto the surface of a breaded, battered, or unbattered prepared food.

3. The process of claim 1 wherein the protein solution contains from about 1 part of protein to from about 6 parts of water to about 15 parts of water.

4. The process of claim 1, wherein the protein solution contains from about 1 part of protein to from about 6 parts of water to about 10 parts of water.

5. The process of claim 1, wherein the protein is selected from meat, poultry and fish, including shell fish, and vegetable.

6. The process of claim 5, wherein the protein of the protein solution is meat.

7. The process of claim 5, wherein the protein of the protein solution is poultry.

8. The process of claim 5, wherein the protein of the protein solution is fish.

9. The process of claim 5, wherein the protein of the protein solution is shell fish.

10. The process of claim 5, wherein the protein of the protein solution is vegetable.

11. The process of claim 6, wherein the meat is selected from the group consisting of beef, lamb, pork, venison, veal, elk, and buffalo

12. The process of claim 7, wherein the poultry is selected from the group consisting of chicken, turkey, duck, game bird, and goose.

13. The process of claim 8, wherein the fish is selected from the group consisting of deboned flounder, sole, haddock, cod, sea bass, salmon, tuna, pollock and trout.

14. The process of claim 9, wherein the shell fish is selected from the group consisting of shelled/unshelled shrimp, crabmeat, crayfish, lobster, scallops, and oysters.

15. The process of claim 10, wherein the vegetable is selected from soy or pea.

16. The process of claim 1, wherein the prepared food is selected from the group consisting of meat, poultry and fish, including shell fish, and vegetable.

17. The process of claim 16, wherein the prepared food is meat.

18. The process of claim 16, wherein the prepared food is poultry.

19. The process of claim 16, wherein the prepared food is fish.

20. The process of claim 16, wherein the prepared food is shell fish.

21. The process of claim 16, wherein the prepared food is vegetable.

22. The process of claim 17, wherein the meat is selected from the group consisting of beef, lamb, pork, venison, veal, elk, and buffalo

23. The process of claim 18, wherein the poultry is selected from the group consisting of chicken, turkey, duck, game bird, and goose.

24. The process of claim 19, wherein the fish is selected from the group consisting of deboned flounder, sole, haddock, cod, sea bass, salmon, tuna, pollock and trout.

25. The process of claim 20, wherein the shell fish is selected from the group consisting of shelled/unshelled shrimp, crabmeat, crayfish, lobster, scallops, and oysters.

26. The process of claim 21, wherein the vegetable is selected from the group consisting of potato, sweet potato, carrot, parsnip, cauliflower, okra, onion, green beans, eggplant, corn, or zucchini.
